(19) United States
(12) Patent Application Publication
(10) Pub. No.: US 2011/0159279 A1
(43) Pub. Date: Jun. 30, 2011

(54) SURFACE-COVERED CERMET MEMBER AND METHOD FOR MANUFACTURING SAME

(75) Inventors: Takashi Kobayashi, Aichi (JP); Kiyoshi Uchida, Aichi (JP); Kimihisa Hiramoto, Tochigi (JP)

(73) Assignee: SHOWA DENKO K.K., Tokyo (JP)

(21) Appl. No.: 13/061,341

(22) PCT Filed: Aug. 28, 2009
(86) PCT No.: PCT/JP2009/065045

§ 371 Date: Feb. 28, 2011

(30) Foreign Application Priority Data
Aug. 29, 2008 (JP) 2008-221369

(51) Int. Cl. C22C 29/00; B05D 3/02; B05D 5/00; B32B 9/00; B21C 23/00

(52) U.S. Cl. 428/336; 427/372.2; 428/698; 428/697; 72/253.1

(57) ABSTRACT

A surface-covered cermet member capable of improving an oxidation resistance while maintaining excellent performance of a titanium series sintered compact is provided. The invention is directed to a surface-covered cermet member in which an oxidation resistant film 12 is formed on a cermet base material 11 made of a sintered compact containing at least one or more titanium compounds selected from titanium carbide, titanium nitride, and titanium carbonitride as a major component of a hard phase. In the surface-covered cermet member of the present invention, the oxidation resistant film 12 is constituted by a complex oxide containing titanium.

### TECHNICAL FIELD

The present invention relates to an surface-covered cermet member in which an oxidation resistant film is formed on a cermet base material constituted by a titanium series sintered compact, and also relates to its related art.

### BACKGROUND ART

A titanium carbonitride series sintered compact (titanium carbonitride group cermet) having titanium carbonitride (TiCN) as a main component of a hard phase and iron group metal as a main component of a binder phase is high in hardness and strength, hardly reacts with aluminum or its alloy, and is high in lubrication with respect to various metals, capable of lowering the coefficient of friction. Because of such excellent characteristics, the titanium carbonitride series sintered compact is preferably used as a metal working member, such as, e.g., a diameter enlarging die, a diameter reducing die, or a cutting tip for a metal pipe.

However, when TiCN series cermet is exposed to an atmosphere containing oxygen at high temperatures, the titanium, which is a constituent element of the cermet, will be oxidized to create titanium oxides on a surface of the cermet. Since this titanium oxide is fragile, performing metalwork using a tool made of cermet having a titanium oxide film results in detachment of the titanium oxide film, causing a rough surface, which in turn deteriorates the machining performance. Furthermore, since the titanium oxide layer becomes quickly worn, the durability of the tool also deteriorates.

Under the circumstances, in order to improve the oxidation resistant performance of the titanium series cermet, conventionally proposed is a method in which different elements are added to elements constituting the cermet.

For example, in the cermet shown in the below-listed Patent Document 1, chromium is added to the titanium series cermet material so that the cermet includes a complex compound of chromium (Cr) and titanium (Ti) as a main component to thereby improve the oxidation resistance.

On the other hand, a number of surface-covered cermet members in which a hard film is formed on a titanium series cermet member have been proposed, although they are not intended to improve the oxidation resistance.

For example, in the surface-covered cermet member shown in the below-listed Patent Document 2, a hard film containing titanium is formed on a surface of the cermet as a base material by, e.g., a CVD method (chemical vapor deposition method) or a PVD method (physical vapor deposition method).

Furthermore, in the surface-covered cermet member shown in the below-listed Patent Document 3, a hard film is formed on a surface of the cermet base material, and a diffusion element contained layer is formed at the interface of the cermet base material surface and the hard film to improve the cohesiveness of the hard film.

### PRIOR ART DOCUMENTS

### Patent Documents

Patent Document 1: JP-A-2006-213977 (Japanese unexamined laid-open patent application publication) (claims)
Patent Document 2: JP-A-2005-111623 (Japanese unexamined laid-open patent application publication) (claims)
Patent Document 3: JP-A-2000-355777(Japanese unexamined laid-open patent application publication) (claims)

### SUMMARY OF THE INVENTION

### Problems to be Solved by the Invention

However, in the cermet (sintered compact) formed by adding additional elements to the elements of the titanium series sintered compact material as taught by the aforementioned Patent Document 1, the cermet is different in component from the titanium series sintered compact and changes in quality, which causes a problem that the excellent performance of the titanium series sintered compact is impaired.

In the surface-covered cermet member disclosed in the aforementioned Patent Document 2, a hard film is simply formed by diffusion. However, the amount of diffusion is different on the binder phase (Co) of the cermet base material and in the hard film phase (TiC). For example, the diffusion hardly occurs on the hard film phase, which causes a problem that the cohesiveness of the hard film deteriorates, which in turn becomes difficult to keep the sufficient oxidation resistance due to the detachment.

In the surface-covered cermet member disclosed in the aforementioned Patent Document 3, a diffusion element contained layer is further formed at the interface of the hard film and the cermet base member, which causes a problem that the structure becomes complicated. This makes it difficult to produce the cermet member.

The present invention was made in view of the aforementioned problems, and aims to provide a titanium series surface-covered cermet member which is capable of improving the oxidation resistance while maintaining the excellent performance of the titanium series surface-covered cermet member and easily produced, and also relates to related technologies thereof.

### Means for Solving the Problems

The present invention has the following structural substance to attain the aforementioned objects.

[1] A surface-covered cermet member comprising:

a cermet base material made of a sintered compact containing at least one or more titanium compounds selected from titanium carbide, titanium nitride, and titanium carbonitride as a major component of a hard phase; and

an oxidation resistant film formed on the cermet base material,

wherein the oxidation resistant film is constituted by a complex oxide containing titanium.

[2] The surface-covered cermet member as recited in the aforementioned Item 1, wherein the titanium compound is constituted by titanium carbonitride.

[3] The surface-covered cermet member as recited in the aforementioned Item 1 or 2, wherein the oxidation resistant film is formed by applying a process liquid containing metal salt which reacts with the titanium compound on a surface of the cermet base material onto the cermet base material to create the complex oxide and thereafter heating the cermet base material.

[4] The surface-covered cermet member as recited in the aforementioned Item 3, wherein, in advance of applying the process liquid, an oxidation treatment of the cermet base material is performed.

[5] The surface-covered cermet member as recited in any one of the aforementioned Items 1 to 4, wherein the oxidation resistant film is constituted by a perovskite-type complex oxide.

[6] The surface-covered cermet member as recited in the aforementioned Item 5, wherein the oxidation resistant film is formed by applying a process liquid containing an alkaline-earth metal compound on the cermet base material and thereafter heating the cermet base material.

[7] The surface-covered cermet member as recited in any one of the aforementioned Items 1 to 4, wherein the oxidation resistant film is constituted by an ilmenite-type complex oxide.

[8] The surface-covered cermet member as recited in the aforementioned Item 7, wherein the oxidation resistant film is formed by applying a process liquid containing a transition metal compound having an iron group divalent ion onto the cermet base material and thereafter heating the cermet base material.

[9] The surface-covered cermet member as recited in any one of the aforementioned Items 1 to 4, wherein the oxidation resistant film is constituted by a spinel-type complex oxide.

[10] The surface-covered cermet member as recited in the aforementioned Item 9, wherein the oxidation resistant film is formed by applying a process liquid containing a magnesium compound or a cobalt compound onto the cermet base material and thereafter heating the cermet base material.

[11] The surface-covered cermet member as recited in any one of the aforementioned Items 1 to 10, wherein a thickness of the oxidation resistant film is 0.5 μm or less.

[12] The surface-covered cermet member as recited in any one of the aforementioned Items 1 to 11, wherein the complex oxide has a crystal structure in which oxygen ions are closest-packed.

[13] An extrusion die for extrusion-molding an extruded member, wherein the extrusion die is made of the surface-covered cermet member as recited in any one of the aforementioned Items 1 to 12.

[14] An extrusion molding method for extrusion-molding an extruded material with a preliminarily heated extrusion die, the method comprising:

using the extrusion die as recited in the aforementioned Item 13;

after initiation of the extrusion-molding, making an oxidation resistant film of the extrusion die detach from the extrusion die with flowing extrusion material.

[15] An oxidation prevention method of a titanium-series sintered compact for preventing oxidation of a sintered compact containing at least one or more titanium compounds selected from titanium carbide, titanium nitride, and titanium carbonitride as a major component of a hard phase, the method comprising:

forming an oxidation resistant film constituted by a complex oxide containing titanium on the titanium series sintered compact.

[16] The oxidation prevention method of a titanium series sintered compact as recited in the aforementioned Item 15, wherein the complex oxide has a crystal structure in which oxygen ions are closest-packed.

[17] A production method of a surface-covered cermet member, the method comprising the steps of:

applying a process liquid containing metal salt which reacts with a titanium compound on a surface of a cermet base material made of a sintered compact containing at least one or more titanium compounds selected from titanium carbide, titanium nitride, and titanium carbonitride as a major component of a hard phase onto the surface of the cermet base material to create a complex oxide; and

thereafter heating the cermet base material to create an oxidation resistant film.

[18] A production method of a surface-covered cermet member, the method comprising the steps of:

subjecting a cermet base material made of a sintered compact containing at least one or more titanium compounds selected from titanium carbide, titanium nitride, and titanium carbonitride as a major component of a hard phase to an oxidization treatment;

applying a process liquid containing metal salt which reacts with the titanium compound on a surface of the cermet base material onto the cermet base material to create a complex oxide; and

heating the cermet base material after applying the process liquid to create an oxidation resistant film.

### Effects of the Invention

According to the surface-covered cermet member of the invention [1], since the cermet member is constituted by a titanium series cermet base material made of a sintered compact containing at least one or more titanium compounds selected from titanium carbide, titanium nitride, and titanium carbonitride as a major component of a hard phase and a complex oxide containing titanium formed on a surface of the cermet base material, the oxidation resistance can be improved while maintaining the excellent performance of the titanium series sintered compact. Furthermore, this surface-covered cermet member can be easily produced by simply forming an oxidation resistant film on the cermet base material.

According to the surface-covered cermet member of the invention [2], the excellent performance of the titanium carbonitride series sintered compact can be attained.

According to the surface-covered cermet member of the invention [3], the cermet member can be more easily produced.

According to the surface-covered cermet member of the invention [4] to [10], the oxidation resistance can be more assuredly improved.

According to the surface-covered cermet member of the invention [11], the smoothness after detachment of the oxidation resistant film can be secured.

According to the surface-covered cermet member of the invention [12], since the complex oxide containing titanium has a crystal structure in which oxygen ions are closest-packed, the cermet member has a stable structure in which oxygen ions hardly move, which enables forming of an oxidation resistant film (passive film) excellent in oxidation resistance.

According to the surface-covered cermet member of the invention [13], an extrusion die which exerts the same effects mentioned above can be provided.

According to the surface-covered cermet member of the invention [14], the excellent performance of the titanium series sintered compact can be more assuredly attained.

By using the oxidation prevention method of a titanium-series sintered compact of the invention [15], the surface-covered cermet member having the aforementioned effects can be assuredly produced.

According to the oxidation prevention method of a titanium-series sintered compact of the invention [16], since the complex oxide including titanium has a crystal structure in which oxygen ions are closest-packed, the cermet member has a stable structure in which oxygen ions hardly move, which enables forming of an oxidation resistant film (passive film) excellent in oxidation resistance.

According to the production method of a surface-covered cermet member of the invention [17] and [18], a surface-covered cermet member improved in oxidation resistance while maintaining the excellent performance of the titanium series sintered compact can be produced.

### BRIEF DESCRIPTION OF DRAWINGS

FIG. 1 is a cross-sectional view schematically showing a surface-covered cermet member according to an embodiment of the present invention.

FIG. 2 is a block diagram showing an example of a production process of the surface-covered cermet member of the embodiment.

FIG. 3 is a block diagram showing another example of a production process of the surface-covered cermet member of the embodiment.

FIG. 4 is a cross-sectional view schematically showing a periphery of an extrusion die of an extruder to which the embodiment of the present invention is applied.

FIG. 5 is a graph showing thermogravimetric changes in a sample of the present invention and a sample of a comparative example.

### BEST MODE FOR CARRYING OUT THE INVENTION

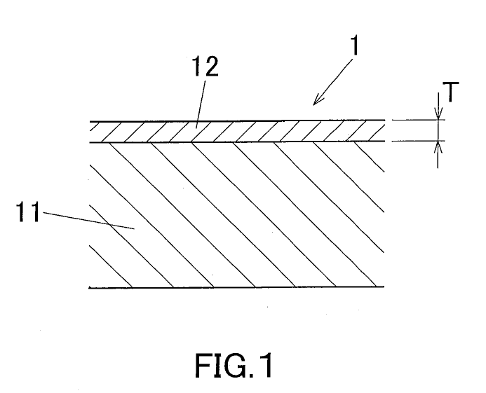

FIG. 1 is a cross-sectional view schematically showing a titanium series surface-covered cermet member 1 according to an embodiment of the present invention. As shown in this figure, the surface-covered cermet member 1 of this embodiment is provided with a cermet base material 11 and an oxidation resistant film 12 formed on the cermet base material 11.

In this embodiment, the cermet base material 11 is constituted by a sintered compact of titanium carbonitride oxide (TiCN). This TiCN series sintered compact (TiCN series cermet) is constituted by a complex material having a hard phase containing titanium carbonitride as a main component (component in which the rate of content in the hard phase is 50% by weight or more) and a binder phase containing iron group metal such as nickel (Ni) or cobalt (Co) as a main component (component in which the rate of content in the binder phase is 50% by weight or more).

In the present invention, the main component of the hard phase of the cermet base material 11 is not limited to titanium carbonitride, and at least one or more types of titanium compounds selected from titanium carbide, titanium nitride, and titanium carbonitride can be employed as the main component of the hard phase. For example, as the main component of the hard phase of the cermet base material 11, a multicomponent titanium compound, such as, e.g., TiCN—WC—TaC, or TiC—WC—TaC, can also be employed.

The oxidation resistant film 12 is constituted by a complex oxide containing titanium. It is preferable that the complex oxide containing titanium has a crystal structure in which oxygen ions are closest-packed. In cases where the complex oxide has a crystal structure in which oxygen ions are closest-packed, it is possible to form an oxidation resistant film (passive film) having a stable structure in which oxygen ions hardly move and excellent in oxidation resistance.

As the complex oxide, for example, perovskite (CaTiO₃)-type complex oxide, ilmenite (FeTiO₃)-type complex oxide, and spinel (mgAl₂O₄)-type complex oxide can be exemplified as preferred examples.

Among other things, perovskite-type complex oxide and ilmenite-type complex oxide are very high in symmetry and stability in crystal structure, which more assuredly prevents movements of oxygen ions. This in turn can form an oxidation resistant film more excellent in oxidation resistance.

As the perovskite-type complex oxide, oxides having a chemical composition, such as, e.g., CaTiO₃, SrTiO₃, or BaTiO₃, can be exemplified.

This perovskite-type complex oxide has, in a structure in which oxygen ions are closest-packed in a face-centered cubit shape, a structure in which cations having a large ionic radius, such as, e.g., Ca²⁺, Sr²⁺, or Ba²⁺, are replaced with oxygen ions at 12-coordinate positions and that a Ti⁴⁺ ion having a small ionic radius is positioned in a gap between an oxygen ion and a positive ion. In other words, it has a structure in which a Ti⁴⁺ ion having a small ionic radius is positioned in a gap between a divalent positive ion having a large ionic radius and an oxygen ion closest packed. This crystal structure is very stable and hardly causes movements of oxygen ions as mentioned above.

The oxidation resistant film 12 made of the aforementioned perovskite-type complex oxide is formed by reacting alkaline earth metal, such as, e.g., Ca, Sr, or Ba, with titanium oxide, such as, e.g., titanium oxide (TiO₂), formed on the surface of the cermet base material.

As the aforementioned ilmenite-type complex oxide, oxides having a chemical composition of, e.g., FeTiO₃, NiTiO₃, CoTiO₃, MnTiO₃, MgTiO₃, or ZnTiO₃ can be exemplified.

This ilmenite-type complex oxide has the same crystal structure as corundum, and has, in a structure in which oxygen ions are closest-packed in a hexagonal closest paced structure, a structure in which cations are positioned at gaps between the oxygen ions. In other words, it has a structure in which ions having a small ionic radius, such as, e.g., Fe²⁺ ion, Ni²⁺ ion, Co²⁺ ion, Mn²⁺ ion, Mg²⁺ ion, or Zn²⁺ ion, and Ti⁴⁺ ion are mingled between the closest-packed oxygen ions. This crystal structure is also very stable and hardly causes movements of oxygen ions as mentioned above.

This oxidation resistant film 12 made of the aforementioned ilmenite-type complex oxide is formed by reacting a transition metal having an iron group divalent ion, such as, e.g., Fe, Ni, Co, Mn, Mg, or Zn, with titanium oxide formed on the surface of the cermet base material.

As the aforementioned spinel-type complex oxide, oxides having a chemical composition of, e.g., MgTi₂O₄, Mg₂TiO₄, CoTi₂O₄, or CO₂TiO₄ can be exemplified.

This spinel-type complex oxide has a structure in which oxygen ions are closest-packed in a face-centered cubit shape. The spinel-type complex oxide containing Ti is different in Ti ionic charge, and is a crystal slightly inferior in stability. In reality, however, no Ti³⁺ ion comes under observation, even in composite oxides having the same elements, it is considered to have a spinel-type structure of Mg₂TiO₄ of quadrivalent Ti, not MgTi₂O₄ of trivalent Ti, in which Mg is positioned in the so-called A-site and Mg and Ti⁴⁺ are positioned in the so-called B-site.

On the other hand, in the present invention, anatase-type, rutile-type, or Brookite-type titanium oxides formed on the cermet base material 11 will not be employed as the oxidation resistant film 12. In such titanium oxides, oxygen ions are not closest packed, and it is not compact in structure and brittle. Therefore, in a high-temperature (e.g., 450° C. or above) aerobic environment, a titanium oxide layer grows thick as time passes, and numerous cracks and holes are formed in the layer, which makes it difficult to attain sufficient oxidation resistance.

The rutile-type titanium oxide is relatively high in symmetrical property among titanium oxides, but has an octahedral crystal structure of TiO₆ with a central distorted portion and lacks stability. Therefore, it has a number of voids, causing easy movements of oxygen ions, which makes it difficult to prevent oxidation thereof.

In this embodiment, it is preferably adjusted such that the thickness T of the oxidation resistant film 12 formed on the cermet base material 11 is 0.5 μm or less, preferably 0.4 μm or less, more preferably 0.1 μm or more. If the thickness T is too thick, as will be detailed later, there is a possibility that the surface from which the oxidation resistant film 12 was detached from the extrusion die constituted by the surface-covered cermet member 1 of this embodiment becomes rough. To the contrary, if the thickness T is too thin, there is a possibility that it becomes difficult to obtain sufficient oxidation prevention effects.

Next, a process for forming the oxidation resistant film 12 on the cermet base material 11 will be explained.

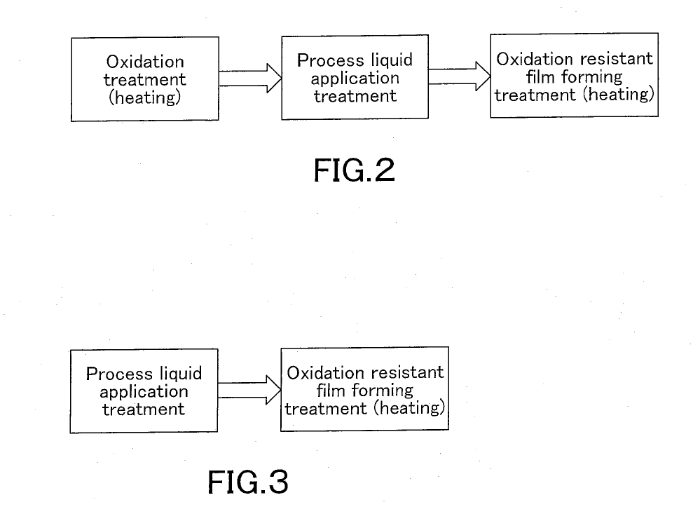

As shown in FIG. 2, in this embodiment, initially a cermet base material 11 is heated to execute the oxidation treatment thereof. Thereafter, a process liquid containing a prescribed metal salt is applied onto the surface of the cermet base material (process liquid application treatment). Thereafter, after drying, the cermet base material 11 is heated to react the metal salt in the process liquid with the titanium oxide on the surface of the cermet base material 11 to thereby create a complex oxide as the oxidation resistant film 12.

In this embodiment, the metal salt which creates a perovskite-type complex oxide by reacting with titanium oxide is an alkaline earth metal compound, such as, e.g., Ca, Sr, or Ba, and this alkaline earth metal compound is contained in the process liquid. As such alkaline earth metal compound, calcium acetate (e.g., calcium acetate.monohydrate) can be exemplified.

The metal salt which creates ilmenite-type complex oxide is a transition metal compound having an iron group divalent ion, such as, e.g., Fe, Ni, Co, Mn, Mg, or Zn, and this transition metal compound is contained in the process liquid. As such transition metal compound, nickel acetate (e.g., nickel acetate (II).tetrahydrate) can be exemplified.

The metal salt which creates spinel-type complex oxide is a salt of Mg or Co, and these metal compounds are contained in the process liquid. As such metal compounds, cobalt acetate (e.g., cobalt acetate (II).tetrahydrate) can be exemplified.

On the other hand, as the process liquid containing metal salt, aqueous or nonaqueous medium is used depending on various additives to be added.

Further, the film forming process liquid should have an appropriate “wetting property” with respect to the surface of the cermet base material 11. If the “wetting property” is poor, the solution liquid will be repelled by the surface of the cermet base material when applying onto the surface of the cermet base material, causing insufficient quantity for application, which may make it difficult to create a desired oxidation resistant film 12. Therefore, when the “wetting property” is poor, the problem should be solved. As the solution, a method of forming a very thin oxide layer on the surface of the cermet base material 11 by oxidizing the surface with hydrogen peroxide solution or oxidizing the surface by heating it in the atmosphere can be preferably employed. The “wetting property” can be improved by adding an appropriate additive such as a surfactant to the process solution.

Furthermore, when applying the process solution on the cermet base material 11, the “drooping” problem of the process solution occurs depending on the viscosity of the process solution. When this “drooping” occurs, it becomes difficult to create a desired oxidation resistant film 12 due to the insufficient process liquid. Especially, in the case of the three-dimensional shape, due to the existence of raising portions, “drooping” readily occurs at the raising portions. In the case of a process liquid using aqueous medium, in order to solve the “drooping” problem, it is preferable to add an aqueous paste (thickener) to the process liquid to give an appropriate viscosity to thereby prevent occurrence of the “drooping”, and perform the subsequent steps such as a drying treatment and a heat treatment with the drooping prevented assuredly.

Depending on the type and/or concentration of the paste, the coated film after the drying step may sometimes be detached due to the shrinkage. This shrinkage detachment problem can be solved by adding aqueous multiple alcohol having a relatively high boiling point as plasticizer. By this addition, the film can keep the flexibility even after the drying step.

When the solubility of the metal salt in the process liquid is low, precipitation of the metal salt sometimes occurs. This problem can be solved by adding organic acid, such as, e.g., formic acid, acetic acid, or citric acid, to the solution liquid.

In cases where it is required to lower the creation temperature of the complex oxide (e.g., 500° C. or below), the lowering of the creation temperature can be attained by adding sodium salt (e.g., sodium hydrogen carbonate) for creating complex oxides at lower temperatures as a reaction auxiliary.

As mentioned above, the aqueous process liquid is constituted by a liquid containing, for example, paste, surfactant, plasticizer, organic acid, and reaction auxiliary in addition to metal salt or solvent, and having viscosity such as slurry or paste.

As a method of applying the process liquid onto the surface of the cermet base material 11, applying the process liquid with a brush or the like, spraying the process liquid with a spray device, or immersing the cermet base material 11 into the process liquid can be employed.

In this embodiment, after drying the process liquid applied on the cermet base material 11, heat treatment is performed to create a oxidation resistant film 12. In the case of not adding sodium salt, it is preferable that the heating conditions at the time of creating the film are set to 380 to 700° C. for 1 to 60 minutes, more preferably 570 to 620° C. for 2 to 20 minutes in the air. In other words, excessively high heating temperatures may cause precedence of oxidation over creation of the oxidation resistant film 12, and excessively low heating temperatures or excessively short heating times may cause insufficient creation of the oxidation resistant film 12 or excessively thin film, which may result in insufficient oxidation resistance effects.

In the aforementioned example, prior to the application of the process liquid onto the cermet base material 11, an oxidation treatment by heating is performed. Although it is preferable to accelerate the oxidation of titanium by a heat treatment prior to the application of the process liquid, it should be noted that such heating oxidation treatment is not always required, and can be omitted. That is, as shown in FIG. 3, without executing a heating oxidation treatment, it can be performed such that the process liquid is immediately applied to the cermet base material (process liquid application treatment), thereafter drying and then heating it to execute an oxidation resistant film forming process. Even if an advance oxidation treatment is not executed as mentioned above, a certain level of a titanium oxide film is formed on the surface of the cermet base material 11 at the time of forming the oxidation resistant film. Thus, the titanium oxide reacts with the process liquid to create a desired oxidation resistant film 12.

Needless to say, even in the case of creating either one of oxidation resistant films made of a perovskite-type complex oxide, an ilmenite-type complex oxide, or a spinel-type complex oxide, the oxidation treatment before application of the process liquid can be omitted.

As mentioned above, the oxidation resistant film 12 is formed on the surface of the titanium carbonitride series cermet base material 11. Thus, a TiCN series surface-covered cermet member 11 according to this embodiment is produced. In this surface-covered cermet member 11, the structural component of the cermet base material 11 is the same as the structural component of the TiCN series sintered compact and the properties of the base material 11 do not change. Thus, the excellent properties of the TiCN series sintered compact can be assuredly obtained.

Furthermore, the surface-covered cermet member 1 of this embodiment can be easily produced by simply applying the process liquid onto the cermet base material 11 and heating it.

Especially in this embodiment, the oxidation resistant film 12 is created by reacting the metal salt of the process liquid with the titanium oxide film formed on the cermet base material 11. Therefore, without being influenced by the types of elements contained in the cermet base material, the oxidation resistant film 12 can be assuredly created, more readily creating the oxidation resistant film 12, which in turn can more easily produce the surface-covered cermet member 1.

As will be apparent from the following examples, in the surface-covered cermet member of this embodiment, the oxidation resistance performance especially in a high temperature environment can be improved.

The surface-covered cermet member 1 of this embodiment can be preferably used as an extrusion die. When employing as an extrusion die, it is practical to constitute not the entirety of an extrusion die but a part of the extrusion die with the surface-covered cermet member 1.

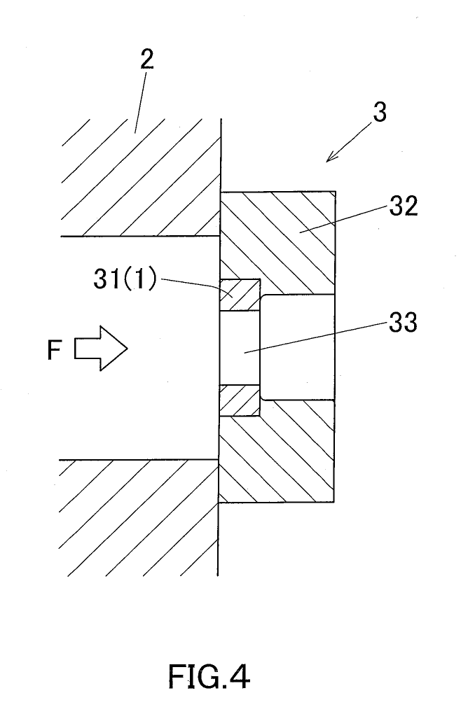

For example, the extrusion die 3 for use in an extruder shown in FIG. 4 is equipped with a die main body 31 such as a bearing portion and a die holder 32 for supporting the die main body 31, the die main body 31 of the extrusion die 3 is constituted by the surface-covered cermet member 1 and the die holder 32 is constituted by a steel product. In producing this extrusion die 3, for example, a cermet base material 11 as the die main body 31 is inserted in the die holder 32 in a heated state and shrunk fitted therein, and then the oxidation resistant film 12 is formed on the cermet base material 11 as mentioned above to provide the die main body 31 constituted by the surface-covered cermet member 1.

If the temperature for creating the oxidation resistant film 12 is set to a temperature exceeding the tempering temperature of the steel material, the hardness of the die holder 32 deteriorates. Therefore, the film creating temperatures should be set to the same as or lower than the tempering temperature of the steel material. In the case of SKD61 hot die steel, it is preferable to create complex oxides at 520° C. or below. This condition can be matched by, for example, adjusting the temperatures to about 500° C. and setting the heating time to about 30 minutes, which enables forming of the oxidation resistant film 12 having a film thickness of about 0.2 μm. The heating temperature at the time of creating the film is lower than a temperature for creating a general oxide film, and therefore the adhesiveness of the oxidation resistant film 12 to the cermet base material 11 is not so high. In this embodiment, however, the oxidation resistant film 12 is required to be immediately removed (detached) from the cermet base material 11 after the initiation of the extrusion molding. For this reason, even if the adhesiveness of the oxidation resistant film 12 is not so high, no problem occurs. Rather, the adhesiveness meets the requirement in which the oxidation resistant film 12 is quickly removed as required.

The following explanation is directed to the case in which an extrusion molding is preformed using the aforementioned extrusion die 3. Prior to the actual extrusion molding, the extrusion die 3 is generally preheated in a preheating furnace. At the time of this preheating, although the extrusion die 3 is exposed in an oxygen atmosphere at high temperatures, since the die main body 31 of the extrusion die 3 is constituted by the surface-covered cermet member 1, the oxidation of the cermet base material 11 can be prevented, which prevents creation of titanium oxides. Accordingly, the surface embrittlement due to the creation of the titanium oxides can be prevented, enabling effective detachments at the time of the extrusion molding to be performed later, which in turn can improve the abrasion resistance and the endurance.

After completion of the preheating, with the extrusion die 3 set to the container 2 of the extruder, extrusion molding is initiated. At the time of this extrusion molding, the extrusion material (metal material F) in the container 2 flows toward the extrusion die 3 in a pressurized state, and passes through the bearing hole 33 of the extrusion die 3 to be molded. When the extrusion molding is initiated, the oxidation resistant film 12 of the surface-covered cermet member 1 constituting the die main body 31 is scraped away by the extrusion material F following in a pressurized state, resulting in quick removal (detachment) of the oxidation resistant film 12. As a result, the die main body 31 is constituted by the cermet base material 11 with the film exposed. Thus, the die main body 31 can fully exert the excellent performance (e.g., hardly reacting with aluminum or its alloy) owned by TiCN series sintered compact (cermet base material). Accordingly, for example, sufficient dimension stability, strength and hardness of the die main body 31 can be secured, enabling high precision extrusion molding stably and smoothly. This enables production of an extruded product high in quality in terms of the surface state and the dimensional accuracy and also can prevent early deterioration, breakage, and detachment, which in turn can assuredly improve the resistance to deterioration, the abrasion resistance, and the durability, etc. Furthermore, by using the TiCN sintered compact as a die, the weight reduction of the die can be attained.

In this embodiment, it is preferable to configure such that the oxidation resistant film 12 of the die main body (surface-covered cermet member 1) is detached by 90% or more as compared with the extrusion preinitiation when the extrusion material is extruded by 10 m from the extrusion initiation. If the amount of detachment of the oxidation resistant film after the extrusion is too small, there is a possibility that it becomes difficult for the TiCN series sintered compact to fully exert the excellent performance.

In the aforementioned embodiment, the explanation is made by exemplifying the case in which a surface-covered cermet member related to the present invention is applied to an extrusion die. But the surface-covered cermet member of the present invention is not limited to the above, and can also be applied to another members including, for example, a plastic forming die including a drawing die such as a diameter enlarging die and a diameter reducing die, a forging processing die, or a die casting die, or a cutting machine tool such as a cutting tip or a bit.

### EXAMPLES

### Example 1

In the same manner as in the aforementioned embodiment, a cermet base material constituted by a titanium carbonitride series sintered compact was prepared. Also prepared as a process liquid for forming an oxidation resistant film was a mixture in which 9.3 mass parts of nickel acetate (II).tetrahydrate, 4.7 mass parts of polyvinyl pyrrolidone (paste agent), 1.9 mass parts of alkylglucoside (surfactant), 5.6 parts of glycerin (multiple alcohol), 4.9 pass parts of citric acid, 6.5 mass parts of sodium hydrogen carbonate (sodium salt), and 67.1 mass parts of water were mixed.

After applying a process liquid onto the surface of the cermet base material, the cermet base material with the process liquid was dried and heated in a circulating hot air furnace in the atmosphere (in the air) while raising the temperature to 500° C. Further, the cermet base material was held at 500° C. for 30 minutes to create an oxidation resistant film constituted by ilmenite-type complex oxides (NiTiO₃ layer) on the cermet base material. Thus, a surface-covered cermet member was obtained. In this case, the oxidation resistant film created on the surface exhibits bluish interference colors.

The obtained surface-covered cermet member was subjected to a test regarding thermogravimetrical changes under the following conditions based on a TGA (thermogravimetrical analysis, thermogravimetrical measurement).

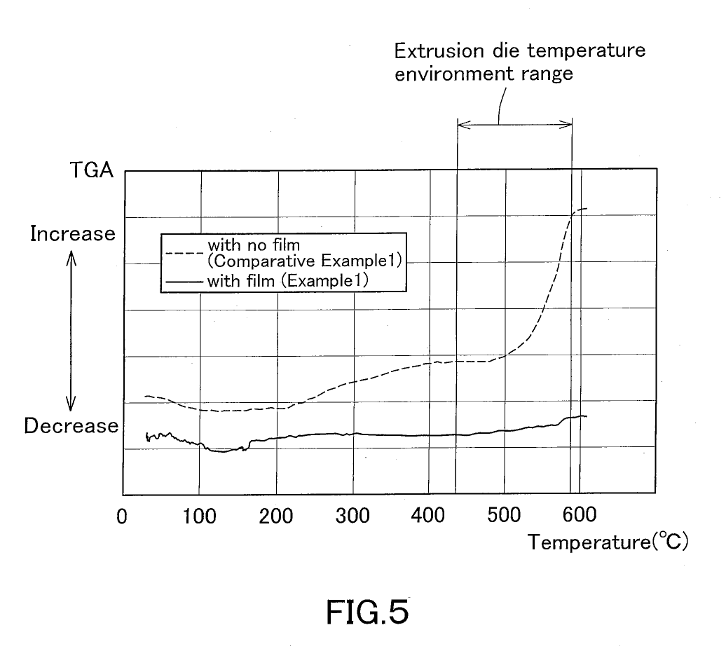

At this time, as the testing device, a device named DTG60H made by Shimadzu Seisakusyo (SHIMADZU CORPORATION) was used. As the test sample of the surface-covered cermet member of this Example 1, a sample of 3 mm×4 mm×0.15 mm was used. This sample was set in the testing device with the sample accommodated in an alumina cell, and the thermogravimetrical changes were measured in the atmosphere (in the air) with the rate of temperature increase set to 1° C./min. The measured results are shown in FIG. 5

### Comparative Example 1

Using a cermet base material constituted by the same titanium carbonitride series sintered compact as in Example 1 but no oxidation resistant film was formed as a sample of a comparative example, the same test as mentioned above was performed. The test results are shown in FIG. 5.

<Evaluation of Oxidation Resistance>

As apparent from FIG. 5, in Example 1 in which an oxidation resistant film was formed, regardless of the heating temperature raising, almost no weight change (weight increase) was recognized, which revealed no progress of oxidation.

On the other hand, in Comparative Example in which no oxidation resistant film was formed, as the heating temperature raises, the weight increased, which reveals a progress of oxidation. Especially, in this Comparative Example, in the extrusion die temperature environment range, the weight increased suddenly, which revealed a sudden progress of oxidation.

As mentioned above, in Example 1, even if the surface-covered cermet member is exposed in an oxygen atmosphere at high temperatures, the oxidation of the cermet base material can be assuredly prevented. Thus, it is considered that problems due to oxidation, such as, e.g., breakage or detachment due to the surface embrittlement, can be effectively prevented.

### Example 2

In the same manner as in the aforementioned embodiment, a cermet base material constituted by a titanium carbonitride series sintered compact was prepared.

Furthermore, as a process liquid, prepared was a mixture in which 9.8 mass parts of calcium acetate monohydrate, 3.9 mass parts of polyvinyl pyrrolidone (paste agent), 1.4 mass parts of alkylglucoside (surfactant), 4.4 parts of glycerin (multiple alcohol), 24.4 mass parts of acetic acid, 4.9 mass parts of sodium acetate (sodium salt), and 51.2 mass parts of water were mixed. After applying this process liquid onto the surface of the cermet base material, the cermet base material with the process liquid was heated in a circulating hot air furnace (electrical furnace) in the air while raising the temperature to 500° C. Further, the cermet base material was held at 500° C. for 30 minutes to create an oxidation resistant film constituted by perovskite-type complex oxides (CaTiO₃ layer) on the cermet base material. Thus, a surface-covered cermet member of Example 2 was obtained. In this case, the oxidation resistant film created on the surface exhibits somewhat glossy silver grayish colors.

The test sample of the surface-covered cermet member of Example 2 was subjected the same test as mentioned above. As a result, the same evaluation as mentioned above was obtained. That is, also in Example 2, no sudden weight increase was observed up to the temperature range of 600° C. Thus, it was confirmed that the surface-covered cermet member was excellent in oxidation resistance.

### Example 3

As a process liquid, prepared was a mixture in which 14.7 mass parts of cobalt acetate (II) tetrahydrate, 6.2 mass parts of polyvinyl pyrrolidone (paste agent), 1.8 mass parts of alkylglucoside (surfactant), 2.1 parts of glycerin (multiple alcohol), and 75.2 mass parts of water were mixed. After applying this process liquid onto the surface of the cermet base material made of the same titanium carbonitride series sintered compact as in Example 1, the cermet base material with the process liquid was heated in a circulating hot air furnace (electrical furnace) in the air while raising the temperature to 600° C. Further, the cermet base material was held at 600° C. for 30 minutes to create an oxidation resistant film constituted by spinel-type complex oxide oxides (CO₂TiO₄ layer) on the cermet base material. Thus, a surface-covered cermet member of Example 3 was obtained. In this case, the oxidation resistant film exhibits dull but glossy bluish colors.

The test sample of the surface-covered cermet member of Example 3 was subjected the same test as mentioned above. As a result, the same evaluation as mentioned above was obtained. That is, also in Example 3, no sudden weight increase was observed up to the temperature range of 600° C. Thus, it was confirmed that the surface-covered cermet member was excellent in oxidation resistance.

Next, in order to evaluate the practical oxidation resistance of each of the obtained surface-covered cermet members of Examples 1-3 and Comparative Example 1, a die main body 31 of the extrusion die 3 shown in FIG. 4 was constituted by each of the aforementioned surface-covered cermet members, and extrusion molding of an aluminum around bar was performed using the extrusion die 3.

The production of the extrusion die 3 was performed as follows. A cermet base material 11 as a die main body 31 was inserted in the die holder 32 made of steel material in a heated state and shrunk fitted therein. Thereafter, the oxidation resistant film was formed on the cermet base material 11 to produce a die main body 31 by the surface-covered cermet member. Thus, an extrusion die 3 was produced. The heating temperature at the time of creating the oxidation resistant film was set to 500° C. and the heating time was set to 30 minutes to thereby create an oxidation resistant film 12 having a thickness of 0.2 μm.

Next, in performing the extrusion molding using the extrusion die 3, the extrusion die 3 was preheated at 450° C. for 300 minutes in a preheating furnace. Thereafter, an extrusion molding of an aluminum round bar was performed at a billet temperature of 450° C. with the extrusion die 3 set in the container 3 of the extruder. The depth of wear of the surface-covered cermet member 1 as the die main body 31 when the extrusion length reached 50,000 m was evaluated. The evaluation results of the depth of wear are shown in Table 1.

TABLE 1

| | Cermet base | Oxidation resistant | Depth |
|---|---|---|---|
| | material | film | of wear (μm) |
| Example 1 | TiCN series sintered | Ilmenite-type | 4 |
| | compact | complex oxide | |
| | | (NiTiO₃) | |
| Example 2 | TiCN series sintered | Perovskite-type | 4 |
| | compact | complex oxide | |
| | | (CaTiO₃) | |
| Example 3 | TiCN series sintered | Spinel-type | 5 |
| | compact | complex oxide | |
| | | (Co₂TiO₄) | |
| Comparative | TiCN series sintered | Nil | Larger than |
| Example 1 | compact | | 30 μm |
| Comparative | WC-Co hard metal | Nil | 7 |
| Example 2 | | | |

As apparent from Table 1, when performing extrusion molding using the extrusion die using the surface-covered cermet member of Examples 1-3 of the present invention, the depth of wear of the surface-covered cermet member was small, resulting in sufficient durability as an extrusion die.

On the other hand, when performing extrusion molding using the extrusion die using the surface-covered cermet member of Comparative Example 1 in which no oxidation resistant film (surface coat) was formed, the 50,000 m extrusion evaluation could not be performed. In other words, when the extrusion length reached 10,000 m, the depth of wear of the surface-covered cermet member reached 30 μm, and it was confirmed that detachments on the surface of the surface-covered cermet member were occurred when the extrusion length reached 10,000 m. In this Comparative Example 1, wear occurred extremely quickly as compared with a conventional WC—Co hard metal series member of Comparative Example 2.

This application claims priority to Japanese Patent Application No. 2008-221369 filed on Aug. 29, 2008, the disclosure of which is incorporated by reference in its entirety.

The terms and expressions which have been employed herein are used as terms of description and not of limitation, and there is no intent, in the use of such terms and expressions, of excluding any of the equivalents of the features shown and described or portions thereof, but it is recognized that various modifications are possible within the scope of the invention claimed

### INDUSTRIAL APPLICABILITY

The surface-covered cermet member of the present invention can be applied to a metal working product such as a cutting tool or an extrusion die.

### DESCRIPTION OF REFERENCE NUMERALS

1 surface-covered cermet member
11 cermet base material
12 oxidation resistant film
3 extrusion die
F extruding material
T film thickness

1. A surface-covered cermet member comprising:
a cermet base material made of a sintered compact containing at least one or more titanium compounds selected from titanium carbide, titanium nitride, and titanium carbonitride as a major component of a hard phase; and
an oxidation resistant film formed on the cermet base material,
wherein the oxidation resistant film is constituted by a complex oxide containing titanium.

2. The surface-covered cermet member as recited in claim 1, wherein the titanium compound is constituted by titanium carbonitride.

3. The surface-covered cermet member as recited in claim 1, wherein the oxidation resistant film is formed by applying a process liquid containing metal salt which reacts with the titanium compound on a surface of the cermet base material onto the cermet base material to create the complex oxide and thereafter heating the cermet base material.

4. The surface-covered cermet member as recited in claim 3, wherein, in advance of applying the process liquid, an oxidation treatment of the cermet base material is performed.

5. The surface-covered cermet member as recited in claim 1, wherein the oxidation resistant film is constituted by a perovskite-type complex oxide.

6. The surface-covered cermet member as recited in claim 5, wherein the oxidation resistant film is formed by applying a process liquid containing an alkaline-earth metal compound on the cermet base material and thereafter heating the cermet base material.

7. The surface-covered cermet member as recited in claim 1, wherein the oxidation resistant film is constituted by an ilmenite-type complex oxide.

8. The surface-covered cermet member as recited in claim 7, wherein the oxidation resistant film is formed by applying a process liquid containing a transition metal compound having an iron group divalent ion onto the cermet base material and thereafter heating the cermet base material.

9. The surface-covered cermet member as recited in claim 1, wherein the oxidation resistant film is constituted by a spinel-type complex oxide.

10. The surface-covered cermet member as recited in claim 9, wherein the oxidation resistant film is formed by applying a process liquid containing a magnesium compound or a cobalt compound onto the cermet base material and thereafter heating the cermet base material.

11. The surface-covered cermet member as recited in claim 1, wherein a thickness of the oxidation resistant film is 0.5 im or less.

12. The surface-covered cermet member as recited in claim 1, wherein the complex oxide has a crystal structure in which oxygen ions are closest-packed.

13. An extrusion die for extrusion-molding an extruded member, wherein the extrusion die is made of the surface-covered cermet member as recited in claim 1.

14. An extrusion molding method for extrusion-molding an extruded material with a preliminarily heated extrusion die, the method comprising:
using the extrusion die as recited in claim 13;
after initiation of the extrusion-molding, making an oxidation resistant film of the extrusion die detach from the extrusion die with flowing extrusion material.

15. An oxidation prevention method of a titanium-series sintered compact for preventing oxidation of a sintered compact containing at least one or more titanium compounds selected from titanium carbide, titanium nitride, and titanium carbonitride as a major component of a hard phase, the method comprising:
forming an oxidation resistant film constituted by a complex oxide containing titanium on the titanium series sintered compact.

16. The oxidation prevention method of a titanium series sintered compact as recited in claim 15, wherein the complex oxide has a crystal structure in which oxygen ions are closest-packed.

17. A production method of a surface-covered cermet member, the method comprising the steps of:
applying a process liquid containing metal salt which reacts with a titanium compound on a surface of a cermet base material made of a sintered compact containing at least one or more titanium compounds selected from titanium carbide, titanium nitride, and titanium carbonitride as a major component of a hard phase onto the surface of the cermet base material to create a complex oxide; and
thereafter heating the cermet base material to create an oxidation resistant film.

18. A production method of a surface-covered cermet member, the method comprising the steps of:
subjecting a cermet base material made of a sintered compact containing at least one or more titanium compounds selected from titanium carbide, titanium nitride, and titanium carbonitride as a major component of a hard phase to an oxidization treatment;
applying a process liquid containing metal salt which reacts with the titanium compound on a surface of the cermet base material onto the cermet base material to create a complex oxide; and
heating the cermet base material after applying the process liquid to create an oxidation resistant film.
